(19) United States
(12) Patent Application Publication
(10) Pub. No.: US 2012/0081547 A1
(43) Pub. Date: Apr. 5, 2012

(54) CONDUCTING SURVEILLANCE USING A DIGITAL PICTURE FRAME

(76) Inventors: Bernd Sitzmann, Fort Collins, CO (US); Fred Charles Thomas, III, Fort Collins, CO (US); Paul Boerger, Loveland, CO (US); John Michael Main, Fort Collins, CO (US)

(21) Appl. No.: 12/897,852

(22) Filed: Oct. 5, 2010

(51) Int. Cl. H04N 7/18

(52) U.S. Cl. 348/143; 348/E05.133; 348/E07.085

(57) ABSTRACT

Embodiments disclosed herein relate to conducting surveillance using a digital picture frame. A digital picture frame may comprise a sensor and a storage medium. The digital picture frame may receive surveillance information from the sensor and store the surveillance information in the storage medium. A second electronic device may receive the surveillance information from the digital picture frame via a network.

### BACKGROUND

Automated surveillance systems are often used to monitor places or people. For example, a store may have a surveillance system that includes a camera for recording video footage of the store. The video footage in some cases may be sent to a separate electronic device where it may be reviewed to determine if any suspicious activity occurred within the store. Surveillance systems are useful to track information from a remote location. Surveillance systems may be used to track many types of information, such as to monitor temperature, gas, light, or noise. Surveillance systems include, for example, a baby monitor used to monitor a baby's activity or a health surveillance system to monitor the activity of an elderly person. Surveillance systems may be used to monitor conditions in an area, such as carbon monoxide levels.

### BRIEF DESCRIPTION OF THE DRAWINGS

In the accompanying drawings, like numerals refer to like components or blocks. The drawings describe example embodiments. The following detailed description references the drawings, wherein:

FIG. 1 is a block diagram illustrating an example of a computing system.

FIG. 2 is a block diagram illustrating an example of a computing system.

FIG. 3 is a flow chart illustrating an example of a method for conducting surveillance using a digital picture frame.

FIG. 4 is a block diagram illustrating an example of a computing system.

FIG. 5 is a flow chart illustrating an example of conducting audio surveillance using a digital picture frame.

FIG. 6 is a flow chart illustrating an example of conducting smoke detection surveillance using a digital picture frame.

### DETAILED DESCRIPTION

Surveillance systems may be used to automatically monitor an area. For example, a surveillance system may collect data and send it to another location for review. In some cases, Closed Circuit Video (CCV) monitors are used for surveillance. For example, a store may set up large CCV monitors for videoing shoppers. Other surveillance monitoring systems include, for example, a baby monitor, smoke detector, or noise detector.

In some cases, surveillance systems are expensive, large, or unattractive. A surveillance system may have a distinctive appearance that makes its use as a surveillance system known. In addition, large surveillance systems may not be portable in some cases. For example, a large surveillance system may be set up for a primary location. Other issues associated with surveillance systems include, for example, interference with other devices communicating using the same radio frequency.

Digital picture frames are often used as home décor items. For example, a digital picture frame may provide an attractive electronic device that acts as a picture frame displaying multiple pictures. A digital picture frame may retrieve pictures from a storage, such as a flash drive or x-D picture card, for display on the digital picture frame.

In one embodiment, a digital picture frame is configured as a surveillance system for capturing surveillance information and sending it to a remote electronic device for review. A digital picture frame may in some cases provide a surveillance system that is inexpensive, aesthetically attractive, and portable. A digital picture frame may include a sensor, such as a gas, light, noise, or video sensor, for collecting surveillance information. The digital picture frame may include a communication mechanism for sending the collected surveillance information via a network. For example, the digital picture frame may have networking capabilities to wirelessly send the surveillance information to another electronic device. In some cases, a digital picture frame may continue to act as a typical digital picture frame while acting as a surveillance device. For example, a digital picture frame may monitor carbon monoxide levels while displaying pictures on the digital picture frame's display. In one implementation, a digital picture frame may receive settings associated with conducting surveillance, such as settings related to where to transmit surveillance information, the type of surveillance information to collect, or when to collect surveillance information.

A digital picture frame may be configured to serve as different types of surveillance devices. For, example, a digital picture frame may be used as a baby monitor. A digital picture frame may display pictures in a nursery while also including a noise sensor. Information collected by the noise sensor may be sent to another electronic device, such as an electronic device in possession of a parent monitoring the sounds in the nursery. Using a digital picture frame allows for a portable surveillance system that may double as a home décor item. For example, a user may chose to no longer use the digital picture frame as a baby monitor. The digital picture frame may include communication capabilities, such as wireless 802.11 protocol communication capabilities, unlikely to result in interference with other electronic devices.

As another example, a digital picture frame may be used as a surveillance system in an office. The digital picture frame may appear as a typical digital picture frame displaying pictures, but it may also include a video camera sensor for collecting video information. The digital picture frame may then send the video information to another electronic device for review. By acting as a digital picture frame displaying pictures, the digital picture frame may disguise its surveillance capabilities. A surveillance camera on a digital picture frame may be more attractive than other types of surveillance monitors. In addition, the smaller size of a digital picture frame allows it to be easily transported to different areas for use.

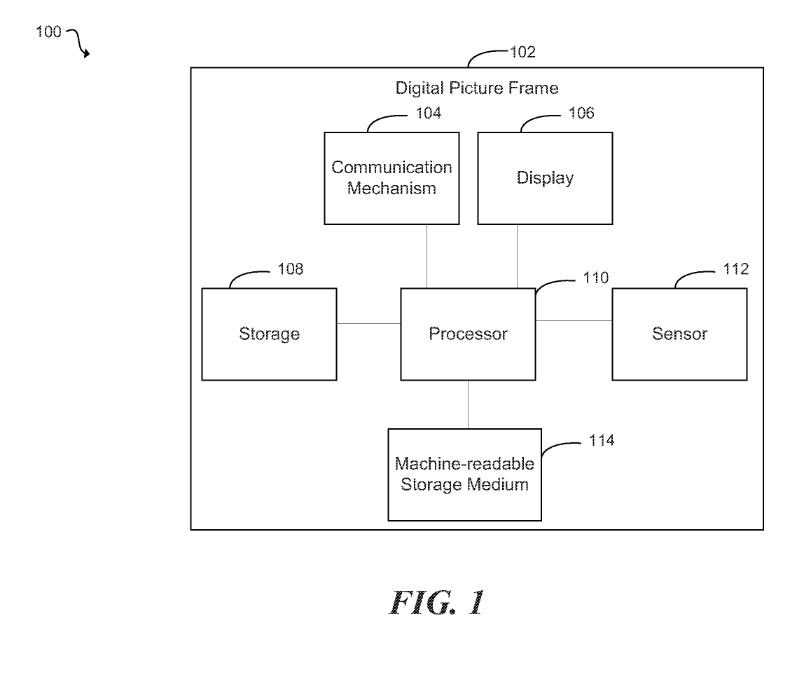

FIG. 1 is a block diagram illustrating an example of a computing system 100. The computing system 100 includes, for example, a digital picture frame 102. The digital picture frame 102 may be any suitable digital picture frame. The digital picture frame 102 may be, for example, a consumer display device for displaying still images or video images in a home or office environment. The digital picture frame 102 may be approximately the size of a non-electronic picture frame, such as a digital picture frame for displaying images approximately 4 inches by 6 inches or 5 inches by 7 inches. The digital picture frame 102 may include, for example, a communication mechanism 104, a display 106, a storage 108, a processor 110, a sensor 112, and a machine-readable storage medium 114.

The processor 110 may be any suitable processor. For example, the processor 110 may be one or more central processing units (CPUs), semiconductor-based microprocessors, and/or other devices suitable for retrieval and execution of instructions stored in machine-readable storage medium 114. The processor 110 may fetch, decode, and execute instructions stored in the machine-readable storage medium 114 to implement the functionality described in detail below. As an alternative or in addition to fetching, decoding, and executing instructions, the processor 110 may include one or more integrated circuits (ICs), such as integrated circuits on a computer chip, or other electronic circuits that comprise a plurality of electronic components for performing the functionality described below. The processor 110 may, for example, run a proprietary operating system associated with the digital picture frame 102.

The sensor 112 may be any suitable sensor. For example, the sensor 112 may monitor conditions around the digital picture frame 102. The sensor 112 may be, for example, a microphone, camera, video camera, motion sensor, gas sensor, smoke sensor, thermometer, or light sensor. In some implementations, the digital picture frame 102 includes multiple sensors. For example, the digital picture frame 102 may include both a smoke sensor and a heat sensor for acting as a fire alarm. The digital picture frame 102 may include a motion sensor for activating the digital picture frame 102 to notify that another sensor, such as a video camera sensor, should start collecting surveillance data. The sensor 112 may in some cases be hidden or placed in a covert position on the digital picture frame 102 such that a person is unlikely to notice that the digital picture frame 102 is collecting surveillance information.

The storage 108 may be any suitable storage. For example, the storage 108 may be a volatile or non-volatile storage. The storage 108 may be, for example, flash memory. In one embodiment, the storage 108 stores information collected by the sensor 112. The storage 108 may also store image or video data to be displayed on the display 106. For example, the digital picture frame 102 may display images from the storage 108 while storing surveillance information in the storage 108.

The communication mechanism 104 may be any suitable communication mechanism. The communication mechanism 104 may be, for example, a wireless signal transmitter for communicating via a wireless network using an 802.11 protocol or Bluetooth®. The communication mechanism 104 may communicate surveillance information stored in the storage 108 with a second electronic device via a network, such as the Internet, a wired local area network, or a wireless local area network.

The display 106 may be any suitable display, such as a Liquid Crystal Display (LCD) screen. In one embodiment, the display 106 displays images, such as still images or video. The display 106 may display images while the sensor 112 collects information. In one implementation, the display 106 displays images unrelated to the data collected by the sensor 112. In one embodiment, the display 106 displays information collected by the sensor 112.

The machine-readable storage medium 114 may be any electronic, magnetic, optical, or other physical storage device that stores executable instructions or other data (e.g., a hard disk drive, random access memory, flash memory, etc.). In one implementation, the storage 108 and the machine-readable storage medium 114 are combined in the same storage device. The machine-readable storage medium 114 may include instructions executable by the processor 110, for example, instructions to receive surveillance information from the sensor 112 attached to the digital picture frame 102, store the accessed surveillance information in the storage 108 of the digital picture frame 102, and transmit the surveillance information to a second electronic device via a network

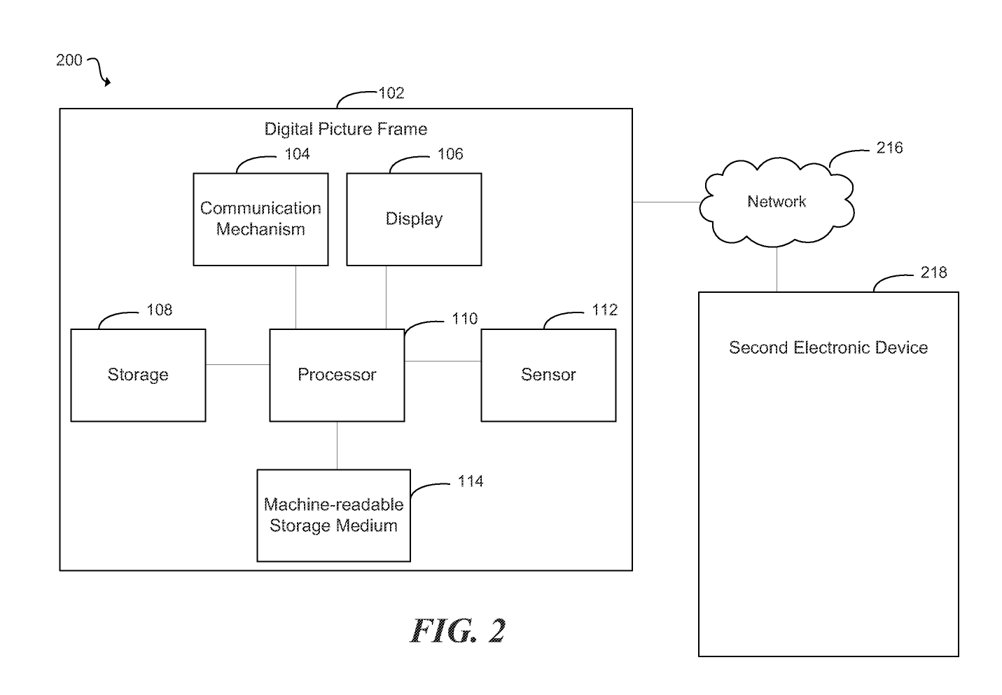

FIG. 2 is a block diagram illustrating an example of a computing system 200. The computing system 200 includes the digital picture frame 102 with the communication mechanism 104, the display 106, the storage 108, the processor 110, the sensor 112, and the machine-readable storage medium 114. The computing system 200 may include a second electronic device 218 and a network 216. For example, the digital picture frame 102 may send information to the second electronic device 218 using the communication mechanism 104 to send the information via the network 216. The network 216 may be any suitable network, such as a wired or wireless local area network or the Internet.

The second electronic device 218 may be any suitable electronic device, such as a server computer, personal computer, or digital picture frame. For example, the second electronic device 218 may receive surveillance information from the digital picture frame 102 and output it for review. The second electronic device 218 may be in a different location than the digital picture frame 102, such as a second electronic device 218 located in a child's home for reviewing surveillance information from a digital picture frame in an elderly parent's home. In one implementation, the second electronic device 218 is a website server, and the surveillance information is broadcast via webcast.

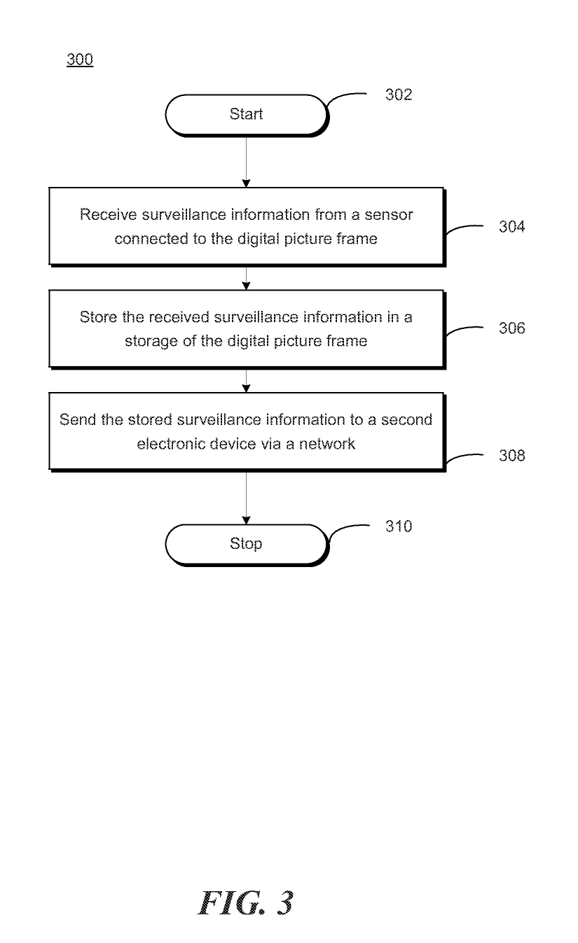

FIG. 3 is a flow chart illustrating an example of a method 300 for conducting surveillance using the digital picture frame 102. For example, the processor 110 may receive surveillance information from the sensor 112 and store the surveillance information in the storage 108. The processor 110 may then send the stored surveillance information via the network 216 to another electronic device, such as the second electronic device 218, using the communication mechanism 104. For example, the surveillance information may be analyzed at the second electronic device 218.

Beginning at block 302 and moving to block 304, the processor 110, such as by executing instructions stored in the machine-readable storage medium 114, receives surveillance information from the sensor 112 connected to the digital picture frame 102. The processor 110 may receive surveillance information from the sensor 112 in any suitable manner, such as via a communication bus or other communication mechanism within the digital picture frame 102. The sensor 112 may collect the surveillance information in any suitable manner. For example, the sensor 112 may be a camera, video camera, thermometer, motion detector, smoke detector, light detector, gas detector, or noise detector.

In one implementation, the processor 110 activates the sensor 112. For example, the processor 110 may receive information from a motion detector that there is activity for the sensor 112 to monitor, and the processor 110 may then activate the sensor 112. In one implementation, the processor 110 activates the sensor 112 based on received user input, such as input to activate the sensor 112 or to activate the sensor 112 at a particular time or day. The input may be received, for example, from an input mechanism on the digital picture frame 102, such as a button or a touch screen on the display 106, or from another electronic device communicating with the digital picture frame 102 via a network.

In one implementation, the processor 110 receives settings information related to collecting surveillance information by the sensor 112 and the processor 110 instructs the sensor 112 to perform surveillance based on the settings information. In one embodiment, the digital picture frame 102 is discoverable by other devices on the network 216 and may receive information, such as settings information, from other devices. The properties may be received in any suitable manner, such as from the digital picture frame 102 or from a remote device, such as a mobile phone, sending information to the digital picture frame 102. The settings information may be received via a menu associated with the digital picture frame 102, such as a touch menu displayed on the display 106 or information received via a human interface device (HID). The settings may be any suitable settings, such as to continuously monitor, to monitor at a particular time, or to monitor if a particular activity is detected. In some cases, a user may want to turn off the sensor 112 such that the digital picture frame 102 functions as a typical digital picture frame without surveillance capabilities. The settings information may include information about what type of information to collect, such as to collect noise information, but not video information.

In one implementation, the sensor 112 is a camera, such as a still camera or video camera, and the settings information related to performing surveillance includes settings information related to operating a camera. For example, the settings information may include information about panning the camera sensor, such as to pan left, right, up, or down, or to spin to pan around an area. The panning setting may be useful for providing information about the location where surveillance information should be gathered. The settings information may include zoom information, such as an amount of zoom or an object or area to zoom in or out. The settings information may include illumination information, such as to illuminate an object with infrared light, or focus information, such as to focus on a particular type of object. In one embodiment, the settings information is provided before surveillance is conducted. In one embodiment, the settings information is provided during the surveillance process. For example, a person observing information received from the digital picture frame 102 may send settings information to the digital picture frame 102 from a remote device, such as to zoom in on a particular object of interest or to pan to an area of suspected activity.

In one implementation, the processor 110 analyzes or updates the surveillance information received from the sensor 112, such as before storing or sending the surveillance information. The processor 110 may access settings information related to processing the surveillance information. For example, the processor 110 may receive audio data from the sensor 112, and the settings information may indicate that visual data is preferred. The processor 110 may create images or text indicating the type of audio information sensed. For example, a text message may be formatted to indicate that the noise level is medium rather than transferring the noise sensed by the sensor 112.

Continuing to block 306, the processor 110, such as by executing instructions stored in the machine-readable storage medium 114, stores the received surveillance information in the storage 108 of the digital picture frame 102. For example, the processor 110 may store the surveillance information in the storage 108 for later retrieval, such as to analyze or to send the surveillance information. In one implementation, the processor 110 temporarily stores the surveillance information so that it may later send it to the second electronic device 218. In one implementation, the processor 110 stores information in the storage 108 and periodically sends the stored information to the second electronic device 218. This may be helpful, for example, if a network connection is not continuously available.

Proceeding to block 308, the processor 110, such as by executing instructions stored in the machine-readable storage medium 114, sends the stored surveillance information to the second electronic device 218 via the network 216. The processor 110 may send the surveillance information in any suitable manner. For example, the communication mechanism 104 may send the surveillance information to the second electronic device 218 via the network 216.

The processor 110 may transmit the surveillance information to any suitable location. For example, the processor 110 may send the surveillance information to another electronic device in a home via a local area network, such as a digital picture frame in a baby's nursery sending sounds to a digital picture frame in a living room. In one implementation, the processor 110 sends the surveillance information to a server such that the surveillance information is available via webcast. For example, a child may monitor an elderly parent by placing a digital picture frame in the parent's home and watching the webcast to monitor. In one implementation, the processor 110 sends an email, text message, voice message, or other communication to an account associated with a person. For example, an email may contain the surveillance information captured by the sensor 112 or a summary of the surveillance information. In one implementation, the processor 110 updates a website feed, such as a Really Simple Syndication (RSS) feed, with the surveillance information. In one embodiment, the digital picture frame 102 may discover other devices and send information to them.

In one implementation, the processor 110 receives settings information related to sending the surveillance information. For example, the processor 110 may receive settings information about when to send surveillance information, such as to send it once a day or when received from the sensor 112. The processor 110 may receive settings information about where to send the surveillance information. For example, the processor 110 may receive settings information indicating that the processor 110 should send collected surveillance information to three separate electronic devices. The processor 110 may receive settings information about specific devices to send the information to or account information for sending the information, such as a phone number.

In one implementation, the processor 110 displays an image, such as a still image or video, on the display 106 of the digital picture frame 102. The digital picture frame 102 may display pictures or video as expected from a digital picture frame. For example, the digital picture frame 102 may display images on the display 106 while the sensor 112 is collecting surveillance information or while the communication mechanism 104 is sending surveillance information to the second electronic device 218. In some cases, the display 106 may continue to show pictures or video while the digital picture frame 102 is not in surveillance mode. For example, a user may chose not to use the surveillance capabilities of the digital picture frame 102.

The display 106 may display any suitable image. For example, a displayed image may be an image stored in the storage 108. The digital picture frame 102 may receive image information, such as from a network, to display. For example, the digital picture frame 102 may display information about weather or news feeds received via a network. In one embodiment, the display 106 displays information collected by the sensor 112, such as information about the current temperature sensed from the sensor 112.

In one implementation, an electronic device receiving the surveillance information may be used to review the surveillance information. For example, a user at the second electronic device 218 may review the surveillance information. The second electronic device 218 may show images, play sounds, or play video related to the received surveillance information. For example, the second electronic device 218 may include speakers or a display. In one embodiment, the second electronic device 218 receives the surveillance information and sends the surveillance information to additional electronic devices. The method 300 continues to block 310 and ends.

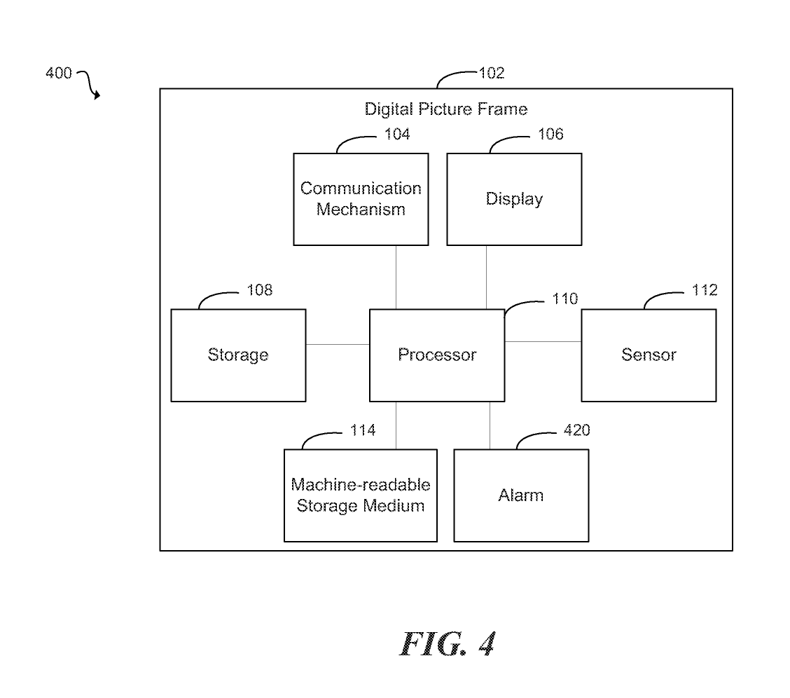

FIG. 4 is a block diagram illustrating an example of a computing system 400. The computing system 400 includes the digital picture frame 102 with the communication mechanism 104, the display 106, the storage 108, the processor 110, the sensor 112, and the machine-readable storage medium 114. The digital picture frame 102 may also include an alarm 420.

The alarm 420 may be any suitable alarm, such as a video, audio, or motion alarm. For example, the alarm 420 may flash a red light, display a message on the display 106, vibrate, or make a loud sound. In one implementation, the processor 110 may receive surveillance information from the sensor 112 and determine whether to activate the alarm 420. For example, the processor 110 may receive criteria related to the alarm 420 and evaluate whether the surveillance information from the sensor 112 meets the criteria. The criteria may be stored, such as in the storage 108. If the processor 110 determines that the surveillance information meets the criteria, the processor 110 may activate the alarm 420. For example, the storage 108 may store criteria indicating that the alarm 420 should be activated if carbon monoxide is detected above X parts per million. The sensor 112 may collect information about carbon monoxide indicating that the carbon monoxide level is above X parts per million. In response, the processor 110 may activate the alarm 420, for example, such that a beeping sound is created. In one implementation, the processor 110 sends information from the sensor 112 to a remote electronic device, such as the second electronic device 218, and the second electronic device 218 analyzes the surveillance information and sends information back to the processor 110 indicating whether the alarm 420 should be activated.

In one implementation, the processor 110 receives settings information about the use of the alarm 420. For example, the processor 110 may receive information about whether to use the alarm 420 and the criteria for activating the alarm 420. The input may be received, for example, from (buttons on the digital picture frame 102, from a touch screen on the display 106, or from a remote device. In some cases, a user may not want the alarm 420 used or may want to select a different criteria for activating the alarm 420 based on the circumstances. The settings information may include information about sending a remote alarm signal, such as sending a text message to a particular person if the surveillance information meets particular criteria. The settings may include information about which alarm to use on a digital picture frame with multiple alarms or how an alarm should be activated, such as how loud the alarm 420 should be.

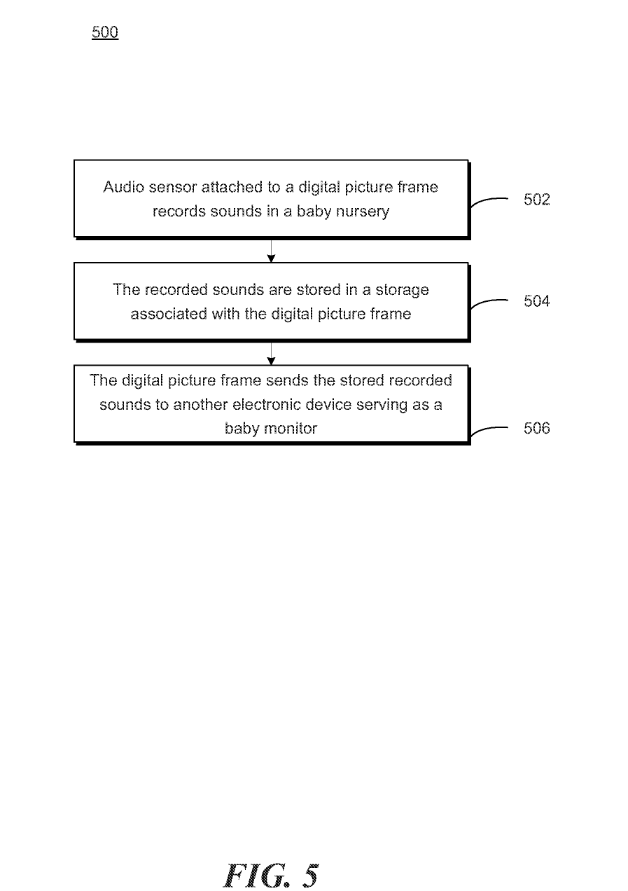

FIG. 5 is a flow chart illustrating an example 500 of conducting audio surveillance using a digital picture frame. A digital picture frame, for example, may serve as a baby monitor while also displaying soothing images to the baby. The digital picture frame may be placed in a baby nursery to monitor the baby's sounds. Beginning at block 502, an audio sensor, such as a microphone, attached to a digital picture frame records sounds in a baby nursery. Moving to block 504, the recorded sounds are stored in a storage associated with the digital picture frame. The storage may be used to store the recorded sounds on a temporary basis until they are sent or for a longer time frame. Continuing to block 506, the digital picture frame sends the stored recorded sounds to another electronic device serving as a baby monitor. For example, the recorded sounds may be sent to another digital picture frame, a mobile phone, or a personal computer. A parent may listen to the sounds in the baby nursery from the electronic device.

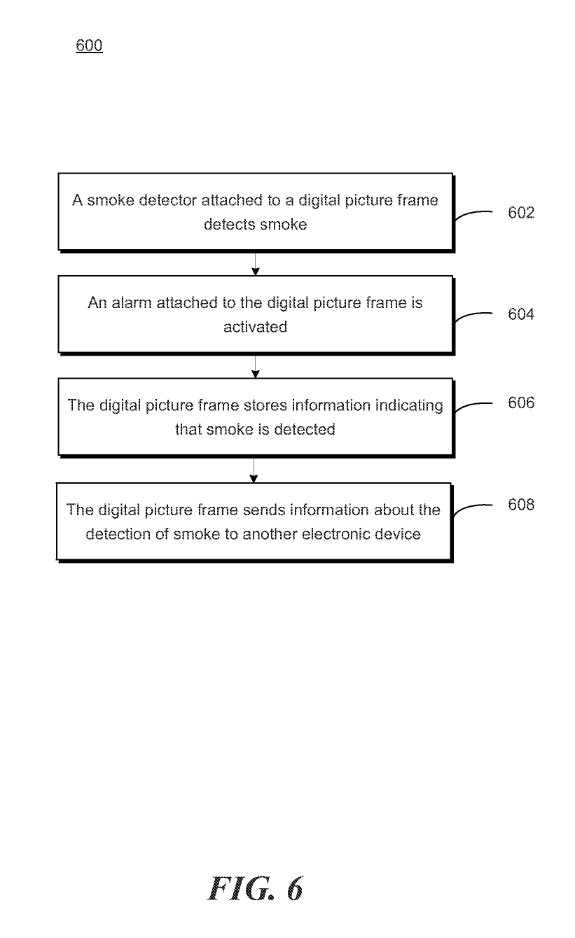

FIG. 6 is a flow chart illustrating an example 600 of conducting smoke detection surveillance using a digital picture frame. For example, a digital picture frame with a smoke detection sensor may be placed in a home to serve as a secondary alarm and to alert a nearby relative of any suspected fires. The digital picture frame may serve as a smart configurable smoke detector capable of alerting remote parties about the presence of smoke. Beginning at block 602, a smoke detector attached to a digital picture frame detects smoke. Moving to block 604, an alarm attached to the digital picture frame is activated. For example, a person may hear the alarm and vacate the area. Continuing to block 606, the digital picture frame stores information indicating that smoke is detected. Proceeding to block 608, the digital picture frame sends information about the detection of smoke to another electronic device. For example, a relative may receive a phone call or text message indicating that smoke was detected so that the relative can call to confirm that situation is safe or may call to send emergency help to the location.

A digital picture frame may provide an inexpensive surveillance system. A digital picture frame may provide a portable surveillance system that may be easily transported between locations. In addition, a digital picture frame may create an aesthetically pleasing surveillance system that is unlikely to be recognized as a surveillance system.

1. A computing system for conducting surveillance using a digital picture frame, comprising:
a digital picture frame, comprising:
a display;
a communication mechanism for communicating via a network;
a storage;
a sensor for collecting surveillance information; and
a processor to:
receive surveillance information from the sensor;
store the surveillance information in the storage; and
send the surveillance information via the communication mechanism to a second electronic device.

2. The computing system of claim 1, wherein the processor further:
receives information indicating settings related to performing surveillance; and
instructs the sensor to perform the surveillance based on the settings.

3. The computing system of claim 2, wherein the sensor comprises a camera and wherein the settings related to performing surveillance comprise settings related to at lead one of: pan, illumination, zoom, or focus.

4. The computing system of claim 1, wherein the processor further:
receives information indicating settings related to sending the surveillance information,
wherein sending the surveillance information comprises sending the surveillance information based on the settings.

5. The computing system of claim 1, wherein the digital picture frame further comprises an alarm, and
wherein the processor further:
receives information indicating criteria for activating the alarm;
determines whether the surveillance information meets the criteria; and
activates the alarm if determined that the surveillance information meets the criteria.

6. A method of conducting surveillance using a digital picture frame, comprising:
receiving, by a processor associated with a digital picture frame, surveillance information from a sensor connected to the digital picture frame;
storing, by the processor, the received surveillance information in a storage of the digital picture frame; and
sending, by the processor, the stored surveillance information to a second electronic device via a network.

7. The method of claim 6, further comprising:
receiving, by the processor, information indicating settings related to performing surveillance; and
instructing, by the processor, the sensor to perform surveillance based on the settings.

8. The method of claim 6, further comprising:
receiving, by the processor, information indicating settings related to sending the surveillance information,
wherein sending the surveillance information comprises sending the surveillance information based on the settings.

9. The method of claim 6, further comprising displaying, by the processor, an image on a display of the digital picture frame.

10. The method of claim 6, further comprising:
receiving, by the processor, information indicating criteria for activating an alarm connected to the digital picture frame;
determining, by the processor, whether the surveillance information meets the criteria; and
activating, by the processor, the alarm if determined that the surveillance information meets the criteria.

11. A machine-readable storage medium encoded with instructions executable by a processor for conducting surveillance using a digital picture frame, the machine-readable medium comprising instructions to:
receive surveillance information from a sensor attached to a digital picture frame;
store the accessed surveillance information in a storage of the digital picture frame; and
transmit the surveillance information to a second electronic device via a network.

12. The machine-readable storage medium of claim 11, further comprising instructions to:
access information indicating properties related to performing surveillance; and
instruct the sensor to perform surveillance based on the properties.

13. The machine-readable storage medium of claim 11, further comprising instructions to:
access information indicating properties related to transmitting the surveillance information,
wherein transmitting the surveillance information comprises transmitting the surveillance information based on the properties.

14. The machine-readable storage medium of claim 11, further comprising instructions to
display an image on a display of the digital picture frame.

15. The machine-readable storage medium of claim 11, further comprising instructions to:
access information indicating criteria for activating an alarm associated with the digital picture frame;
evaluate whether the surveillance information meets the criteria; and
activate the alarm if the surveillance information meets the criteria.
